(19) United States
(12) Patent Application Publication
(10) Pub. No.: US 2012/0246585 A9
(43) Pub. Date: Sep. 27, 2012

(54) SYSTEM FOR EDITING AN AVATAR

(75) Inventors: Brendan K. Reville, Seattle, WA (US); Stacey Law, Redmond, WA (US); Derek Smith, Snohomish, WA (US); Dan B. Kroymann, Bothell, WA (US)

(73) Assignee: MICROSOFT CORPORATION, Redmond, WA (US)

(21) Appl. No.: 12/178,535

(22) Filed: Jul. 23, 2008

Related U.S. Application Data
(60) Provisional application No. 61/080,626, filed on Jul. 14, 2008.

(51) Int. Cl. G06F 3/048

(52) U.S. Cl. 715/764

(57) ABSTRACT

Systems, methods and computer readable media are disclosed for updating the appearance of an avatar that exists across an online multi-player gaming system, including an executing video game. In addition to the general system, systems, methods and computer readable media for updating the avatar, techniques are disclosed for prompting networked video games to update an avatar that has been modified while the video game has been executing.

### PRIORITY

This application claims priority to U.S. patent application Ser. No. ______ (Attorney Docket No. MSFT-6209/324415.01), entitled “Programming APIs for an Extensible Avatar System.”

### CROSS-REFERENCE

This application is related by subject matter to the subject matter disclosed in the following commonly assigned applications, the entirety of which are hereby incorporated by reference herein: U.S. patent application Ser. No. ______ (Attorney Docket No. MSFT-6205/324378.01) titled “An Extensible Animation and Remote System for Platform Avatars”, U.S. patent application Ser. No. ______ (Attorney Docket No. MSFT-6208/324414.01), titled “Avatar Closet/Game Awarded Avatar,” and U.S. patent application Ser. No. ______ (Attorney Docket No. MSFT-6209/324415.01), entitled “Programming APIs for an Extensible Avatar System.”

### BACKGROUND

Video games sometimes feature a user-created avatar as a user-controlled character. Typically, a user may customize the avatar in variety of ways dealing with appearance, such as facial features and clothing. This allows the user a more personalized and involved video gaming experience. For instance, the NINTENDO CORPORATION® has a user-created avatar, the MII®, which a user may then use as his or her user-controlled character in video games that support this feature, such as WII SPORTS®. The avatar-editing and creating process is cumbersome in that it requires the user to completely exit all video games that he or she is playing.

This can prove especially problematic when the video game lacks convenient “save” functionality, requiring the user to either play significantly longer, so as to reach a “save point” or to give up his or her current game and the progress through it that he or she has achieved since the last game save. Even if the user is able to easily save, he or she must still spend time exiting from the game and restarting the game, which detracts from his or her experience.

It would therefore be an improvement to allow a user to create or modify an avatar while executing a video game, and to have that modified avatar appear in that video game when the user resumes playing.

Furthermore, in the case of online multi-player video games, the other users' games typically load a user's avatar information at the start of play, so the user's updated avatar would not appear to the other users until they exited and re-started the video game. This may create a disfavored situation in which the user's avatar has an inconsistent appearance to different users. It would therefore also be an improvement to cause those other users' games to update the user's avatar at the time that the user modifies his or her avatar.

### SUMMARY

In example embodiments of the present disclosure, a method, system and computer readable medium are provided to update the appearance of an avatar that exists across an online multi-player gaming server, including an executing video game. In such a system, a user may have a system-wide avatar that also being used in the currently executing game. Where the user wishes to update the appearance of the avatar while playing the game, the service provides a facility for such updating and storing of said updates, as well as a mechanism for the game to be informed of the update, and load the updated avatar to replace the old avatar in the concurrently executing game.

In example embodiments of the present disclosure, a method system and computer readable medium are provided to update the appearance of an avatar that exists across a user console, and independent of any video game played on the console. In such a system, a user may have a system-wide avatar that also being used in the currently executing game. Where the user wishes to update the appearance of the avatar while playing the game, the service provides a facility for such updating and storing of said updates, as well as a mechanism for the game to be informed of the update, and load the updated avatar to replace the old avatar in the concurrently executing game.

The user's avatar may be stored locally on the console. In one embodiment, this avatar is stored as part of the user's profile. In one embodiment, when the user connects to an online multi-player gaming server, the avatar or profile is synchronized with the service.

A method and computer readable medium are also disclosed that perform comparable functions as the system discussed above.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

The systems, methods, and computer readable media for updating the appearance of an avatar that exists across an online multi-player gaming system, including an executing video game, in accordance with this specification are further described with reference to the accompanying drawings in which:

FIG. 1 illustrates an exemplary console for subject matter discussed in FIGS. 4-5

FIG. 2 illustrates an exemplary computing environment for subject matter discussed with reference to FIGS. 4-5;

FIG.3 illustrates an exemplary networking environment for subject matter discussed with reference to FIGS. 4-5;

FIG.4 illustrates an example procedure for updating the appearance of an avatar across an online video game service.

FIG.5 illustrates an example system for updating the appearance of an avatar across an online video game service.

### DETAILED DESCRIPTION OF ILLUSTRATIVE EMBODIMENTS

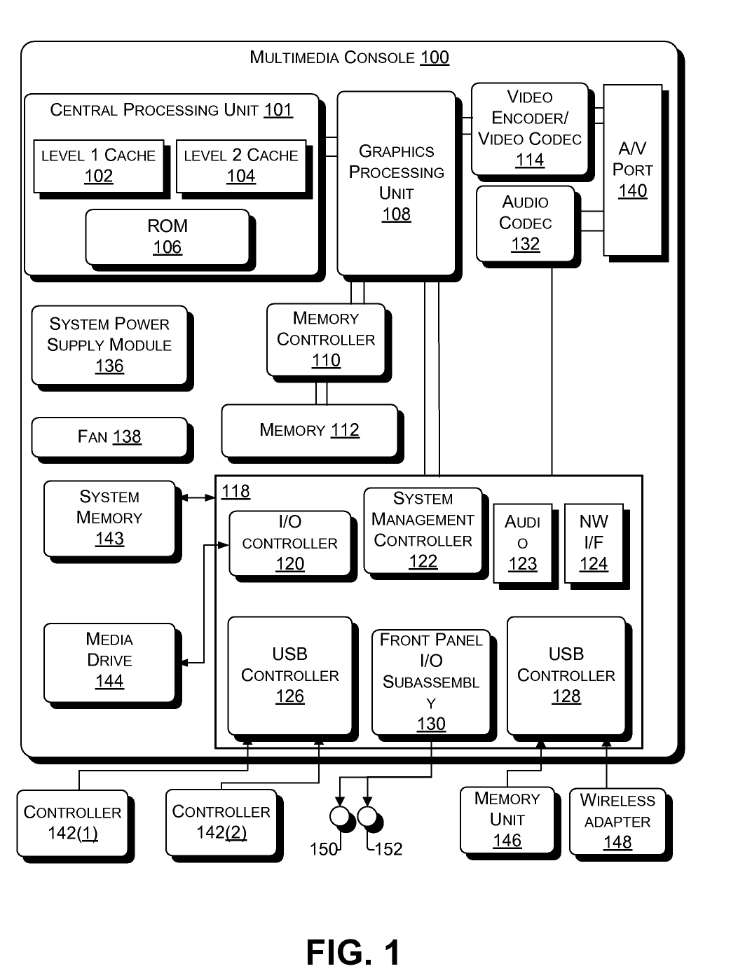

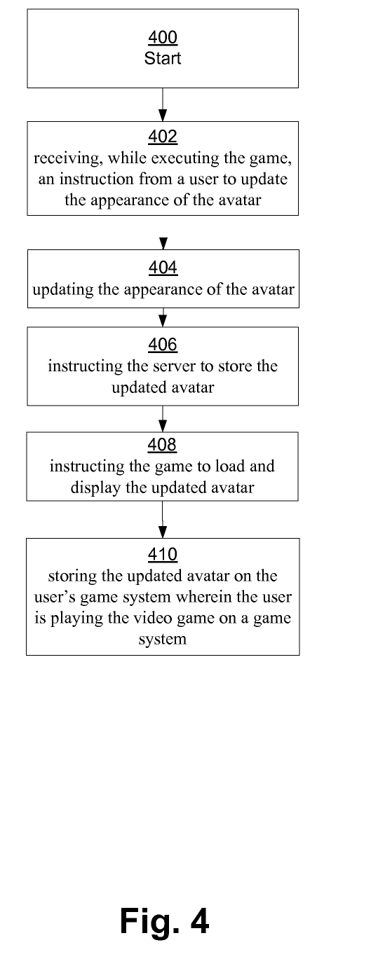

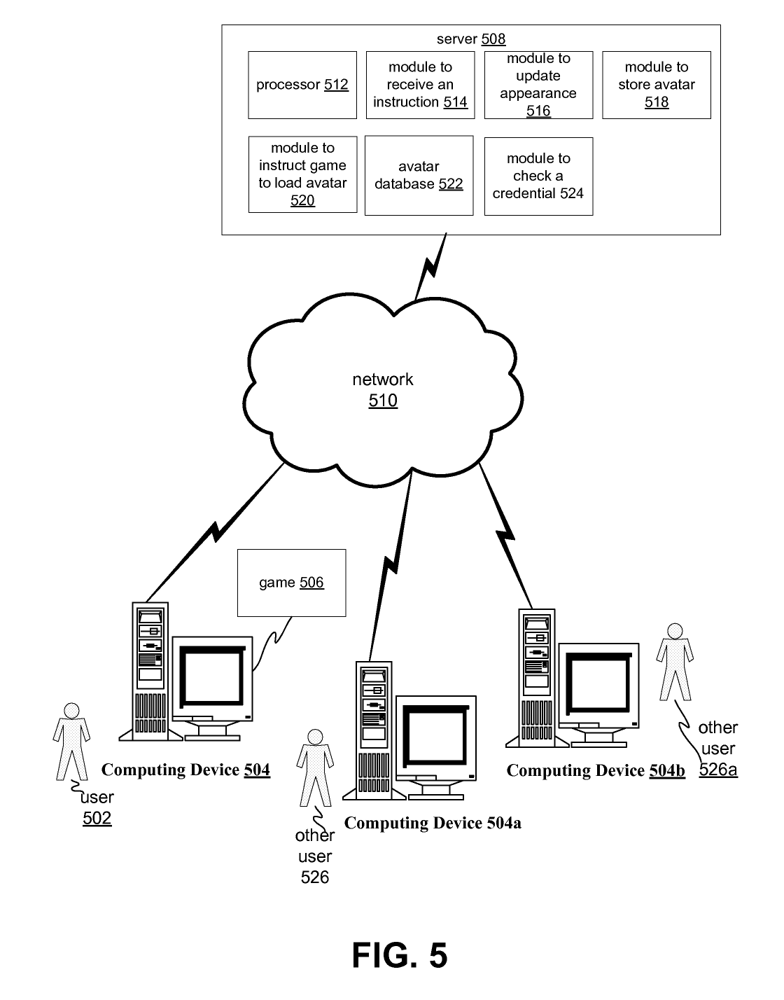

Certain specific details are set forth in the following description and figures to provide a thorough understanding of various embodiments. Those of ordinary skill in the relevant art will understand that they can practice other embodiments without one or more of the details described below. While various methods are described with reference to steps and sequences in the following disclosure, the description as such is for providing a clear implementation of embodiments of the invention, and the steps and sequences of steps should not be taken as required. FIGS. 1-3 illustrates an operating environment in which operating procedures may be performed. FIG. 4 depicts example operating procedures. FIG. 5 depicts a system that comprises at least one embodiment.

### Exemplary Game Console, PC, and Networking Aspects

This section of the present disclosure provides the general aspects of an exemplary and non-limiting game console. Referring now to FIG. 1, a block diagram shows an exemplary multimedia console. The multimedia console 100 has a central processing unit (CPU) 101 having a level 1 (L1) cache 102, a level 2 (L2) cache 104, and a flash ROM (Read-only Memory) 106. The level 1 cache 102 and level 2 cache 104 temporarily store data and hence reduce the number of memory access cycles, thereby improving processing speed and throughput. The flash ROM 106 may store executable code that is loaded during an initial phase of a boot process when the multimedia console 100 is powered. Alternatively, the executable code that is loaded during the initial boot phase may be stored in a flash memory device (not shown). Furthermore, ROM 106 may be located separate from CPU 101.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 and CPU 101 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 1 18. The USB controllers 126 and 128 serve as hosts for peripheral controllers 142(1)-142(2), a wireless adapter 148, and an external memory unit 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless interface components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity, 3D, surround, and stereo audio processing according to aspects of the present disclosure described above. Audio data is carried between the audio processing unit 123 and the audio codec 126 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 1 00.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures.

When the multimedia console 100 is powered on or rebooted, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 may allow one or more users to interact with the system, watch movies, listen to music, and the like. However, with the integration of broadband connectivity made available through the network interface 124 or the wireless adapter 148, the multimedia console 100 may further be operated as a participant in a larger network community. In this latter scenario, the console 100 may be connected via a network to a server.

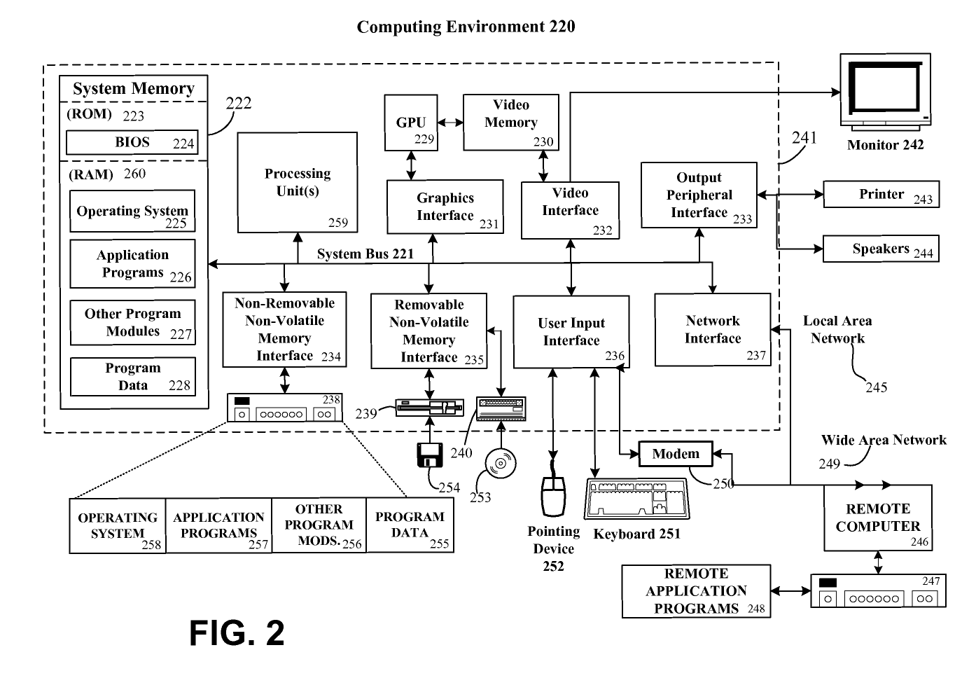

Second, now turning to FIG. 2, illustrated is a block diagram representing an exemplary computing device that may be suitable for use in conjunction with implementing the subject matter disclosed above. Numerous embodiments of the present disclosure may execute on a computer. For example, the computer executable instructions that carry out the processes and methods for providing PC experiences on gaming consoles may reside and/or be executed in such a computing environment as shown in FIG. 1. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computer 241 typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 2 illustrates operating system 225, application programs 226, other program modules 227, and program data 228.

The computer 241 may also include other removable/non-removable, volatile/nonvolatile computer storage media. By way of example only, FIG. 2 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 2, provide storage of computer readable instructions, data structures, program modules and other data for the computer 241. In FIG. 2, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 2. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 2 illustrates remote application programs 248 as residing on memory device 247. It will be appreciated that the network connections shown are exemplary and other means of establishing a communications link between the computers may be used.

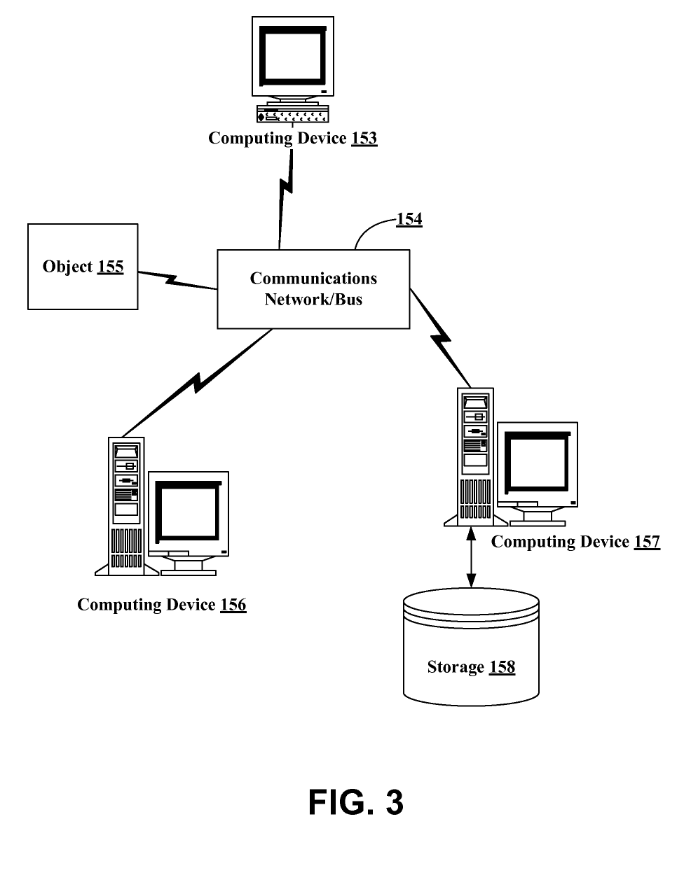

FIG. 3 provides a schematic diagram of an exemplary networked or distributed computing environment. The environment comprises computing devices 153, 156, and 157 as well as object 155 and database 158. Each of these entities 153, 155, 156, 157, and 158 may comprise or make use of programs, methods, data stores, programmable logic, etc. The entities 153, 155, 156, 157, and 158 may span portions of the same or different devices such as PDAs, audio/video devices, MP3 players, smart phones, DVD players, cable box tuners, or just about any computing devices capable of remoted content provided by server PCs. Each entity 153, 155, 156, 157, and 158 can communicate with another entity 153, 155, 156, 157, and 158 by way of the communications network 154. In this regard, any entity may be responsible for the maintenance and updating of a database 158 or other storage element.

This network 154 may itself comprise other computing entities that provide services to the system of FIG. 3, and may itself represent multiple interconnected networks. In accordance with an aspect of the presently disclosed subject matter, each entity 153, 155, 156, 157, and 158 may contain discrete functional program modules that might make use of an API, or other object, software, firmware and/or hardware, to request services of one or more of the other entities 153, 155, 156, 157, and 158.

It can also be appreciated that an object, such as 155, may be hosted on another computing device 156. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 12, any entity 153, 155, 156, 157, and 158 can be considered a client, a server, or both, depending on the circumstances. And, moreover, regarding the entertainment console, it can be a client to a server.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework provided in FIG. 3 and the further diversification that can occur in computing in a network environment such as that of FIG. 3, the systems and methods provided herein cannot be construed as limited in any way to a particular computing architecture or operating system. Instead, the presently disclosed subject matter should not be limited to any single embodiment, but rather should be construed in breadth and scope in accordance with the appended claims. Thus, for example, although game consoles and server PCs have been discussed, just as easily full desktops could be remoted to smart phones as a means to access data and functionality that is otherwise unavailable to smart phones.

Finally, it should also be noted that the various techniques described herein may be implemented in connection with hardware or software or, where appropriate, with a combination of both. Thus, the methods, computer readable media, and systems of the presently disclosed subject matter, or certain aspects or portions thereof, may take the form of program code (i.e., instructions) embodied in tangible media, such as floppy diskettes, CD-ROMs, hard drives, or any other machine-readable storage medium, where, when the program code is loaded into and executed by a machine, such as a computer, the machine becomes an apparatus for practicing the subject matter.

In the case of program code execution on programmable computers, the computing device may generally include a processor, a storage medium readable by the processor (including volatile and non-volatile memory and/or storage elements), at least one input device, and at least one output device. One or more programs that may utilize the creation and/or implementation of domain-specific programming models aspects of the present disclosure, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

### A System for Editing an Avatar

FIG. 4 illustrates an example operational flow for updating the appearance of an avatar across an online video game service, wherein said service comprises a server and an executing video game. Those skilled in the art will note that the disclosed process is illustrative and that different implementations are contemplated.

At 400, the process flow begins. This process may be triggered in response to a user beginning execution of a video game on a video game console that is connected to the online video game service. For example, the user may power on the console, insert a disc that contains computer readable instructions comprising the game, and send an access credential that uniquely The service itself may comprise one or more servers through which online-multiplayer video game play is validated and exchanged between users, a game match-making service that groups users together into a gaming session, an e-commerce marketplace, a message board and a live chat room. The user's avatar may appear in many areas of such a service. For instance it may appear in a user's profile on the service or as a part of any posts the user makes to a message board.

Operation 402 depicts receiving, while executing the game, an instruction from a user to update the appearance of the avatar. While the user is playing the game, he or she may be inspired to change the avatar's appearance. In such an instance, the user may enter a command that calls up an avatar editing screen. For example, the user may press a dedicated button on his or her controller, keyboard or other input device, which brings up a list of commands to be performed. From there, the user may select the command corresponding to editing the appearance of the avatar. While these commands are being entered, the action in the underlying game may continue on or be suspended. The choice between those two options may be made either by the system the game is executing on or by computer readable instructions in the game itself. In one embodiment, receiving an instruction from a user to update the appearance of the avatar includes suspending active play of the game.

Operation 404 depicts updating the appearance of the avatar. The appearance may be any physical aspect of the avatar, such as a hair color, a hair length, a hair style, a facial hair color, a facial hair length, a facial hair style, a facial hair position, an eye color, an eye style, an eye position, a nose style, a nose position, a mouth style, a mouth color, a mouth position, an ear style, an ear position, a skin color, a height, a weight, or a body build.

In an embodiment, updating the appearance of the avatar includes overlaying an editor window on top of the game, and receiving at least one instruction from the user on how to update the appearance of the avatar. For example, the mechanics of updating the avatar may be controlled by the system that the user is playing the game on, rather than the game itself, and the system may render the editor window over the game window before sending the rendered frame to the user's visual display device. When presented with such a window, the user may then send an instruction on how the avatar is to be updated. For instance, the user may click on the avatar's eyes, then select a new eye color from a list of available colors, changing the avatar's eye color from green to hazel.

Operation 406 depicts instructing the server to store the updated avatar. This may include displaying an error message to the server when an indication from the server that it stored the updated avatar is not received within a period of time. Where the server is connected to the user's game system over a communications network, there may be times where the user updates the avatar but the communications network fails to send the updated avatar to the server. In such a case, the user may typically appreciate notification that the changes made to the avatar were not saved. In another embodiment, the changes may be saved locally on the user's game system and further attempts to send the updated avatar to the server may be made until such sending is successful.

Operation 408 depicts instructing the game to load and display the updated avatar. Where the sole non-volatile storage medium for an avatar exists on the server, this may include instructing the game to receive the updated avatar from the server. In another embodiment, the game may read the updated avatar directly from local memory. In the embodiment where the user is playing an online-multi-player video game comprising a session and a plurality of other users participating in said session, and said instructing the game to load and display the updated avatar may include instructing each other user's video game to load and display the updated avatar. That way, the user's avatar will have a consistent appearance for all participants in the multi-player game. This may also include instructing each other user's video game to load the updated avatar after play has been suspended for all other users of the session. It may be confusing to another user when the user's avatar suddenly changes during game play, and a malicious user may rapidly change the appearance of his or her avatar to annoy other users. This can be avoided where avatar changes propagate to all users only when play has been suspended, such as when a match concludes, or all players are paused. This said instructing each other user's video game to load the updated avatar may also include notifying each other user that the user's avatar has been updated. It may be confusing for another user if the user's avatar changes without explicit indication of such, and a notification, such as a pop-up window stating this change, may mitigate this problem.

Operation 410 depicts the optional step of storing the updated avatar on the user's game system wherein the user is playing the video game on a game system. Where communications with the server occur slowly, storing the avatar locally may improve the user experience by speeding up load times.

FIG. 5 depicts a system for updating the appearance of an avatar across an online video game service, wherein said service comprises a server and an executing video game. Those skilled in the art will note that the disclosed process is illustrative and that different implementations are contemplated.

A user 502 uses a computing device 504 to execute a game 506. In an embodiment of the present disclosure, the user connects to an online gaming server 508 through a network 510.

The server 508 comprises a processor 512, a module to receive an instruction from a user to update the appearance of the avatar 514, a module to update the appearance of the avatar 516, a module to store the updated avatar 518,a module to instruct the user's game to load and display the updated avatar 520, a database in which to store an avatar/user pairs 522, and a module to check at least one credential 524.

The computing device 504 may be a dedicated video game console or a more general computing device, such as a cellular telephone or a personal computer. The computing device 504 may be configured to execute a plurality of games. It may have an optical drive and allow for a variety of games to be executed from computer readable instructions stored on optical discs. The games may be stored on a storage device within the computer, such as a hard drive or solid-state drive.

Where the user 502 wishes to update the appearance of the avatar he is using in a video game 506 that he is currently playing, he or she may issue an instruction to the server 508 to update the appearance of said avatar, which is received by the module to receive an instruction from a user to update the appearance of the avatar 514. That instruction is then passed to the module to update the appearance of the avatar 516. When the appearance of the avatar has been updated, a signal is sent from that module 516, to the module to store the updated avatar 516, which stores said avatar in the database 522. The database 522 may store pairs that identify the user and said avatar. Where a user may have a plurality of avatars at one time, the database may store the user and the avatars separately, along with an indication of which avatar corresponds to which user. The module to update the appearance of the avatar 516 also sends a signal to the a module to instruct the user's game to load and display the updated avatar 520, which sends a message to the user's computing device 504 to instruct the game 506 to load and display the updated avatar.

Where a security system is in place, the server may also pass all communications from the user 502 to update the appearance of the avatar through a module to check at least one credential of the user. Where the credential check passes, the user's instruction is processed as above. Where the credential check fails, the user's instruction is not executed. In an embodiment, a message telling the user 502 that the credential check failed may be send to the user's console 504 for display to the user.

Where the user 502 updates the avatar while playing on the service with other users 526a, 526b, through their respective computing devices 504a, 504b, when the server 508 sends a message to the user's console 504 to load and display the user's updated avatar, it may send a message to the other users' consoles 504a, 504b to also load and display the user's updated avatar.

### Conclusion

While the present disclosure has been described in connection with the preferred aspects, as illustrated in the various figures, it is understood that other similar aspects may be used or modifications and additions may be made to the described aspects for performing the same function of the present disclosure without deviating therefrom. Therefore, the present disclosure should not be limited to any single aspect, but rather construed in breadth and scope in accordance with the appended claims. For example, the various procedures described herein may be implemented with hardware or software, or a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

FIG. 3 illustrates an example system for updating the appearance of an avatar across an online video game service.

What is claimed:

1. A method for updating the appearance of an avatar stored on a console and used in a plurality of video games executed on the console, while the console is executing a video game, comprising:
receiving, by the console, while executing the game, an instruction from a user to update the appearance of the avatar;
updating the appearance of the avatar;
storing the updated avatar on the console; and
instructing the game to load and display the updated avatar.

2. The method of claim 1, wherein updating the appearance of the avatar includes:
overlaying on top of the game an editor window; and
receiving at least one instruction from the user on how to update the appearance of the avatar.

3. The method of claim 1, wherein said updating comprises updating one from the set of: a hair color, a hair length, a hair style, a facial hair color, a facial hair length, a facial hair style, a facial hair position, an eye color, an eye style, an eye position, a nose style, a nose position, a mouth style, a mouth color, a mouth position, an ear style, an ear position, a skin color, a height, a weight, and a body build.

4. The method of claim 1, wherein the video game is an online-multi-player video game comprising a session and a plurality of other users participating in said session, and said instructing the game to load and display the updated avatar includes instructing each other user's video game to load and display the updated avatar.

5. The method of claim 1, wherein the video game is an online-multi-player video game comprising a session and a plurality of other users participating in said session, and said instructing the game to load and display the updated avatar includes instructing each other user's video game to load the updated avatar after play has been suspended for all other users of the session.

6. The method of claim 5, wherein said instructing each other user's video game to load the updated avatar includes notifying each other user that the user's avatar has been updated.

7. The method of claim 1, wherein the console is connected to an online multi-player gaming server comprising a message board and said updating includes updating the user's icon on the message board.

8. The method of claim 1, wherein the console is connected to an online multi-player gaming server comprising profiles, each user has a profile, and said updating includes updating the user's profile.

9. The method of claim 1, wherein the console is connected to an online multi-player gaming server comprising credentials, the user has at least one credential, and instructing the server to store the updated avatar includes instructing the server to validate each credential.

10. The method of claim 1, wherein receiving, while executing the game, an instruction from a user to update the appearance of the avatar includes suspending active play of the game.

11. The method of claim 1, wherein instructing the game to load and display the updated avatar further comprises receiving an indication that the console stored the updated avatar.

12. The method of claim 1, wherein storing the updated avatar on the console includes displaying an error message when an indication that the updated avatar was stored is not received within a period of time.

13. The method of claim 1, wherein the console is connected to an online multi-player gaming server, and storing the updated avatar on the console includes storing the updated avatar on the server.

14. The method of claim 13, wherein instructing the game to load and display the updated avatar includes instructing the game to receive the updated avatar from the server.

15. A system for updating the appearance of an avatar across an online video game service, wherein said service comprises a server and an executing video game, comprising:
a processor;
a module to receive an instruction from a user to update the appearance of the avatar;
a module to update the appearance of the avatar;
a module to store the updated avatar; and
a module to instruct the user's game to load and display the updated avatar.

16. The system of claim 16, wherein the online video game service includes at least one from a multi-player video game server, a chat room, a message board, an e-commerce marketplace, and a multi-player video game match-maker.

17. The system of claim 16, wherein the video game is an online-multi-player video game comprising a session and a plurality of other users participating in said session, and said module to instruct the user's game to load and display the updated avatar includes a module to instruct each other user's video game to load the updated avatar after play has been suspended for all other users of the session.

18. The system of claim 17, wherein said module to instruct each other user's video game to load the updated avatar includes a module to notify each other user that the user's avatar has been updated.

19. The system of claim 16, wherein the user has at least one credential, and the module to receive an instruction from a user to update the appearance of the avatar includes a module to validate each credential.

20. A computer readable storage medium for updating the appearance of an avatar across an online video game service, wherein said service comprises a server and an executing video game, wherein the executing video game is an online multi-player video game, the computer readable storage medium including computer executable instructions that when executed perform the method comprising:
receiving, while executing the game, an instruction from a user to update the appearance of the avatar;
overlaying on top of the game an editor window;
receiving at least one instruction from the user on how to update the appearance of the avatar.
updating the appearance of the avatar;
instructing the game to load the updated avatar from the server and display the updated avatar; and
instructing the server to store the updated avatar.
